(19) United States
(12) Patent Application Publication
(10) Pub. No.: US 2007/0030136 A1
(43) Pub. Date: Feb. 8, 2007

(54) On-board illumination controlling system and method

(75) Inventors: Kentaro Teshima, Kariya-city (JP); Kazuhiro Nakashima, Obu-city (JP); Haruyuki Tsuzuki, Toyota-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/485,456

(22) Filed: Jul. 13, 2006

(30) Foreign Application Priority Data
Aug. 3, 2005 (JP) 2005-225543

(51) Int. Cl. B60Q 11/00

(52) U.S. Cl. 340/458

(57) ABSTRACT

An on-board illumination controlling system includes a mobile communicator and an on-board unit. The mobile communicator receives one of request signals and transmits, in response to the received request signal, a response signal. The on-board unit includes: multiple transmitters, a receiver, a comparison ECU and a control ECU. The multiple transmitters are installed, respectively, to different portions of the vehicle. The multiple transmitters transmit, respectively, the request signals to different communication areas. The receiver receives the response signal from the mobile communicator. The comparison ECU specifies one of the multiple transmitters which has transmitted the one of the request signals. The control ECU turns on one of multiple lighting devices in the vehicle corresponding to the specified one of the multiple transmitters.

### CROSS REFERENCE TO RELATED APPLICATION

This application is based on and incorporates herein by reference Japanese patent application No. 2005-225543 filed on Aug. 3, 2005.

### FIELD OF THE INVENTION

The present invention relates to on-board illumination controlling system and method for a vehicle, which include a mobile communicator and an on-board unit and control illumination in the vehicle based on communication between the mobile communicator and the on-board unit.

### BACKGROUND OF THE INVENTION

A conventional on-board illumination controlling system for a vehicle controls illumination in the vehicle based on communication between an on-board unit installed in the vehicle and a mobile communicator carried by a vehicle user. For example, an on-board illumination controlling system disclosed in JP 2004-225471A includes a mobile communicator and an on-board unit and turns on lighting devices located below side rear view mirrors at both sides of the vehicle when an authentication of an ID code is successful, wherein the ID is transferred through a communication between the mobile communicator and the on-board unit is successful. By using the on-board illumination controlling system, a vehicle user having the mobile communicator can easily check situations near the side mirrors. It is therefore possible to improve convenience of the user having the mobile communicator.

However, the on-board illumination controlling system in JP 2004-225471A turns on both the lighting devices of the side mirrors based on the communication between the mobile communicator and the on-board unit. However, only one of lighting devices, which is closer to the user, will help the user to readily operate a door. In addition, the lighting device away from the user consumes electrical power although it hardly contributes to improvement of the convenience in checking the situations at a side of the vehicle to which the user is coming closer.

### SUMMARY OF THE INVENTION

It is therefore an object of the present invention to provide an on-board illumination controlling system for a vehicle which can properly control lighting devices of the vehicle when a user with a mobile communicator comes close to the vehicle.

An on-board illumination controlling system for a vehicle according to one aspect of the present invention includes a mobile communicator and an on-board unit. The mobile communicator receives one of request signals and transmits, in response to the received request signal, a response signal. The on-board unit transmits the request signals, receives the response signal, and controls based on the received response signal multiple lighting devices installed to the vehicle.

In addition, the on-board unit includes multiple transmitters, a receiver, a specifying means and a control means. The multiple transmitters are installed, respectively, to different portions of the vehicle. The multiple transmitters transmit, respectively, the request signals to different communication areas. The receiver receives the response signal from the mobile communicator. The specifying means specifies one of the multiple transmitters which has transmitted the one of the request signals in response to which the mobile communicator has transmitted the received response signal. The control means turns on one of the lighting devices corresponding to the specified one of the multiple transmitters.

When a vehicle user with the mobile communicator comes close to the vehicle and enters one of the communication areas, the response signal is transmitted from the mobile communicator to the on-board unit. In this case, the specifying means specifies one of the transmitters which has transmitted a request signal in response to which the mobile communicator has transmitted the response signal. Then, the control means turns on one of the lighting devices corresponding to the specified transmitter.

Therefore, the on-board illumination controlling system turns on one of the lighting devices according to a portion of the vehicle to which the user with the mobile communicator comes close. The on-board illumination controlling system can thus provide necessary lighting service while minimizing power consumption.

In another aspect of the present invention, an on-board illumination controlling method for a vehicle, an on-board unit for communication with a mobile communicator carried by a vehicle user receives a signal transmitted from the mobile communicator for remotely controlling door condition of the vehicle. The on-board unit determines location of the mobile communicator based on a received signal, and turns on one or a limited number of lighting devices of a vehicle which are closer to a determined location of the mobile communicator than others of the lighting devices.

### BRIEF DESCRIPTION OF THE DRAWINGS

The invention, together with additional objective, features and advantages thereof, will be best understood from the following description, the appended claims and the accompanying drawings. In the drawings:

FIG. 1 is a block diagram showing an on-board illumination controlling system according to the first embodiment of the present invention;

FIG. 2 is a schematic diagram showing an illumination controlling system in the on-board illumination controlling system;

FIG. 3 shows the first correspondence between lighting devices of a vehicle and doors of the vehicle;

FIG. 4 shows the second correspondence between the lighting devices and the doors;

FIG. 5 shows the third correspondence between the lighting devices and the doors;

FIG. 6 shows the fourth correspondence between the lighting devices and the doors;

FIG. 7 is a flowchart showing a process executed by an on-board unit; and

FIG. 8 is a flowchart showing a process for a smart illumination control executed by the on-board unit.

### DETAILED DESCRIPTION OF THE EMBODIMENTS

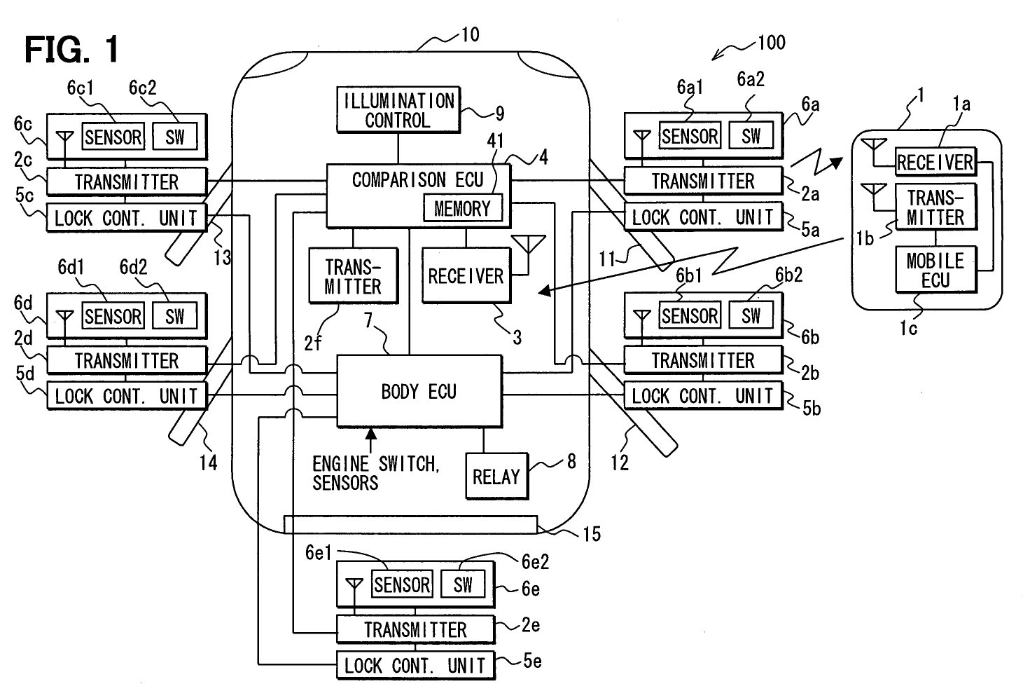

An on-board illumination controlling system according to an embodiment of the present invention includes, as shown in FIG. 1, an on-board unit 100 and a mobile communicator 1. The system thus controls lock/unlock statuses of respective doors 11 to 15 of a vehicle 10 based on a result of a comparison between codes one of which is transmitted through a wireless communication between the mobile communicator 1 and the on-board unit 100. The on-board unit 100 executes smart illumination control for turning on one or more of lighting devices related to one or more of doors to which a vehicle user is coming close with the mobile communicator 1.

As shown in FIG. 1, the mobile communicator 1 includes a receiver 1a, a transmitter 1b and a mobile ECU 1c. The receiver 1a is capable of receiving request signals from vehicle exterior transmitters 2a to 2e and a vehicle interior transmitter 2f.

The vehicle exterior transmitters 2a to 2e are installed, respectively, to the doors 11 to 15. The door 11 is adjacent to a driver's seat of the vehicle 10. The door 12 is adjacent to a seat just behind the driver's seat and is hereafter referred to as a DR seat 12. The door 13 is adjacent to a passenger's seat of the vehicle 10. The door 14 is adjacent to a seat just behind the passenger's seat and is hereafter referred to as a PR seat. The door 15 is for a trunk room of the vehicle 10 and is hereafter referred to as a TR seat. The vehicle interior transmitter 2f is installed in a passenger's compartment of the vehicle 10.

The transmitter 1b transmits in response to the request signal a response signal including a user ID code. The mobile ECU 1c is connected with the receiver 1a and the transmitter 1b and executes several kinds of control processes. More specifically, the mobile ECU 1c determines based on a signal from the receiver 1a whether the receiver 1a has received the request signal. The mobile ECU 1c also generates the response signal including the user ID code and causes the transmitter 1b to transmit the response signal.

The on-board unit 100 includes, in addition to the vehicle exterior transmitters 2a to 2e and the vehicle interior transmitter 2f, a receiver 3, a comparison ECU 4, lock control units 5a to 5e, door handles 6a to 6e, a body ECU 7, a relay circuit 8 and an illumination control apparatus 9. The transmitters 2a to 2f transmit request signals based on a command signal from the comparison ECU 4. The comparison ECU 4 includes a memory 41 which stores correspondence data which will be described later in detail.

The vehicle exterior transmitters 2a to 2e are designed so that the request signal reaches a distance (for example, a distance in a range from 0.7 to 1.0 meters) from one of the vehicle exterior transmitters 2a to 2e which has transmitted the request signal. Each of the vehicle exterior transmitters 2a to 2e thus has a communication area within which the mobile communicator 1 can receive the request signal from the transmitter.

The on-board unit 100 can detect that the mobile communicator 1 has come close to the vehicle 10 when the vehicle 10 is parked and the doors 11 to 15 are locked. The vehicle interior transmitter 2f also has its communication area within which the mobile communicator 1 can receive the request signal from the vehicle interior transmitter 2f. The communication area of the vehicle interior transmitter 2f covers the area in the passenger's compartment. Thus, the on-board unit 100 can detect that the mobile communicator 1 has got in the passenger's compartment. The vehicle interior transmitter 2f may be constituted by two transmitters which are located in the passenger's compartment and have respective two communication areas which cover as a whole the area in the passenger's compartment.

The receiver 3 is installed in the passenger's compartment. The comparison ECU 4 causes the receiver 3 to be ready to receive the response signal, at the same time when the comparison ECU 4 outputs to the transmitters 2a to 2f the command signal requesting for transmitting the request signal. On receiving the response signal from the mobile communicator 1, the receiver 3 outputs the received response signal to the comparison ECU 4. The comparison ECU 4 compares the user ID code in the received response signal with a predetermined user authentication code, to determine whether the user ID code has a predetermined relation with the user authentication code. For example, the comparison ECU 4 compares the user ID code with the user authentication code, to determine whether the user ID code is identical to the user authentication code.

The body ECU 7 controls electrical power supply based on a user's operation of an engine switch of the vehicle. The body ECU 7 also controls the lock/unlock status of the doors 11 to 15 based on the comparison made by the comparison ECU 4. More specifically, the body ECU 7 outputs to the lock control units 5a to 5e located at respective doors 11 to 15 a signal to control the lock/unlock status of the doors 11 to 15. In supplying electrical power to on-board devices, the body ECU 7 activates the relay circuit 8 to supply the electrical power from a battery (not shown) to the on-board devices. The body ECU 7 receives several kinds of signals including signals from the engine switch, a brake pedal sensor (not shown) and a shift position sensor (not shown).

Each of the lock control units 5a to 5e locks and unlocks one of the doors 11 to 15 to which the lock control unit is installed. More specifically, each of the lock control units 5a to 5e includes a door lock motor which rotates in a forward direction or a reverse direction on receiving respectively a lock signal or an unlock signal from the body ECU 7. The door is locked when the door lock motor rotates in the forward direction and unlocked when the door lock motor rotates in the reverse direction.

The door handles 6a to 6e include touch sensors 6a1 to 6e1, respectively. The touch sensors 6a1 to 6e1 are used to detect whether the user having the mobile communicator 1 has touched and operated the door handles 6a to 6e. The doors 11 to 15 are unlocked when an operation to one of the door handles 6a to 6e is detected. The door handles 6a to 6e also include door lock switches 6a2 to 6e2, respectively. Each of the door lock switches 6a2 to 6e2 may be constructed as a push switch. The doors 11 to 15 are locked when one of the door lock switches 6a2 to 6e2 is operated. The door handles 6a to 6e serve as antennas for respective vehicle exterior transmitters 2a to 2e.

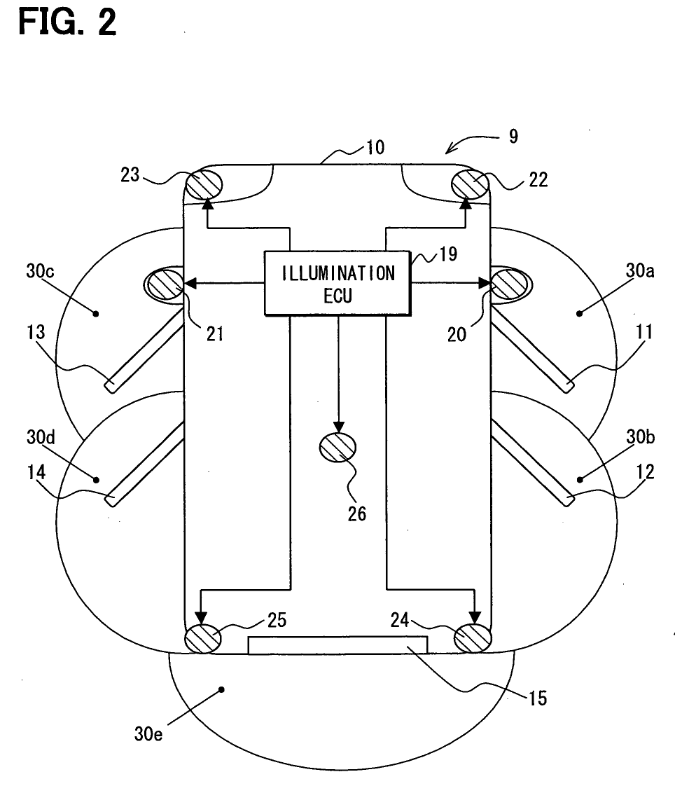

As shown in FIG. 2, the communication areas 30a to 30e for the respective vehicle exterior transmitters 2a to 2e are located adjacent to the respective doors 11 to 15. The request signals transmitted by the vehicle exterior transmitters 2a to 2e include a transmitter code which uniquely specifies one of the vehicle exterior transmitters 2a to 2e which transmits the request signal. As a result, a time dependency of the request signal from one of the transmitters 2a to 2e differs from a time dependency of the request signal from another one of the transmitters 2a to 2e. The mobile communicator 1 puts a transmitter code into the response signal to transmit in response to the request signal including the transmitter code. In other words, the mobile communicator 1 puts a transmitter code unique to a vehicle exterior transmitter into the response signal to transmit in response to a request signal from the vehicle exterior transmitter. As a result, a time dependency of the response signal varies depending on the time dependency of the received response signal. The on-board unit 100 can therefore specify, based on the transmitter code in the response signal, one of the vehicle exterior transmitters 2a to 2e which has transmitted the request signal received by the mobile communicator 1.

Otherwise, the comparison ECU 4 may cause the vehicle exterior transmitters 2a to 2e to transmit the request signals at timings different from each other. The on-board unit 100 can therefore specify, based on a time instant of receiving the response signal, one of the vehicle exterior transmitters 2a to 2e which has transmitted the request signal received by the mobile communicator 1.

When a result of the comparison between the received user ID code in the received response signal and the user authentication code is successful, that is, when the received user ID code has the predetermined relation with the user authentication code, the comparison ECU 4 outputs to the illumination control apparatus 9 information regarding one of the vehicle exterior transmitters 2a to 2e which has transmitted the request signal in response to which the mobile communicator 1 has transmitted the received response signal. The illumination control apparatus 9 executes the smart illumination control based on this information from the comparison ECU 4. More specifically, the illumination control apparatus 9 turns on one or more lighting device corresponding to one or more of the doors 11 to 15 to which a user is coming closer with the mobile communicator 1.

As shown in FIG. 2, the illumination control apparatus 9 includes conventional lighting devices 20 to 26 and an illumination ECU 19. The lighting devices 20 to 26 are installed at different portions of the vehicle 10. The illumination ECU 19 outputs, based on the information from the comparison ECU 4, an activation signal for turning on one or more of the lighting devices 20 to 26 corresponding to one of the doors 11 to 15 to which a user is coming closer with the mobile communicator 1.

A group of the lighting devices 20 to 26 is constructed by a lighting device (hereafter referred to as a D lighting device) 20 installed under a right side mirror closest to the driver's seat, a lighting device (hereafter referred to as a P lighting device) 21 installed under a left side mirror closest to the passenger's seat, a front position light (hereafter referred to as a DF lighting device) 22 installed at a front right corner of the vehicle 10, a front position light (hereafter referred to as a PF lighting device) 23 installed at a front left corner of the vehicle 10, a rear position light (hereafter referred to as a DR lighting device) 24 installed at a rear right corner of the vehicle 10, a rear position light (hereafter referred to as a PR lighting device) 25 installed at a rear left corner of the vehicle 10 and a lighting device,(hereafter referred to as an R lighting device) 26 installed in the passenger's compartment. The conventional lighting devices may include other lighting devices like a direction indicator, a fog light, a cornering light, a brake light and a reverse light. By using the lighting devices 20 to 26, the on-board unit 100 does not need a lighting device specially made for the smart illumination control. Manufacturing cost of the on-board unit 100 is therefore suppressed.

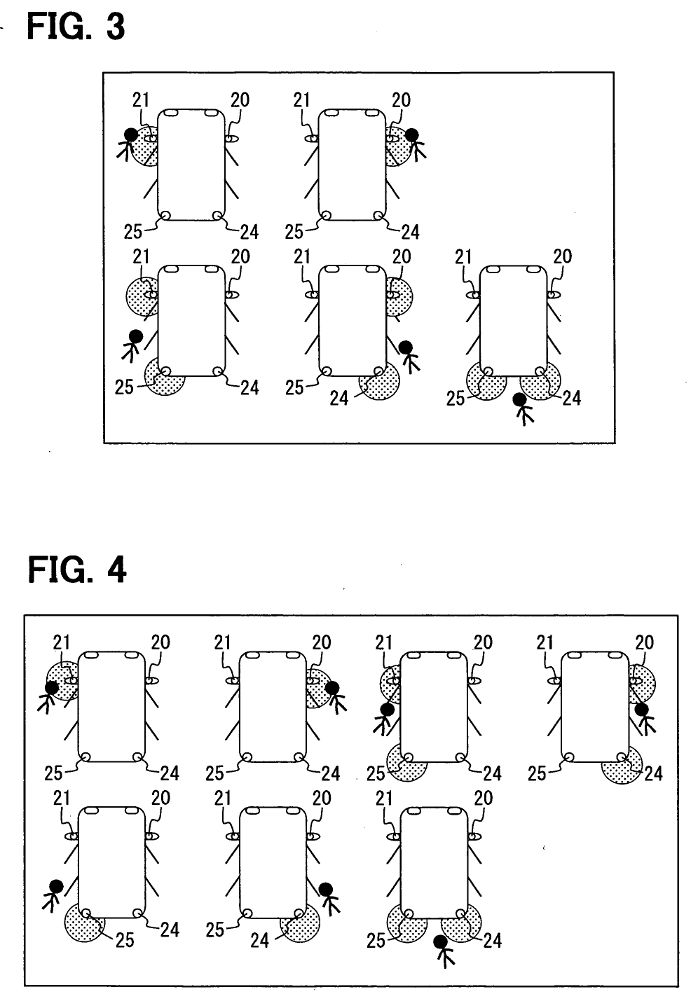

The lighting devices 20, 21, 24 and 25 are correlated to the doors 11 to 15 in the correspondence data indicating a correspondence (hereafter referred to as the first correspondence) between the lighting devices and the doors shown in FIG. 3. In the first correspondence, the door 11 for the driver's seat corresponds to the D lighting device 20. The door 13 for the passenger's seat corresponds to the P lighting device 21. The door 12 for the rear seat (hereafter referred to as a DR seat) just behind the driver's seat corresponds to the D lighting device 20 and the DR lighting device 24. The door 14 for the rear seat (hereafter referred to as a PR seat) just behind the passenger's seat corresponds to the P lighting device 21 and the PR lighting device 25. The door 15 for the rear trunk corresponds to the DR lighting device 24 and the PR lighting device 25.

Some of the lighting devices 20, 21, 24 and 25 are turned on according to the first correspondence when the user comes close to one of the doors with the mobile communicator 1. The on-board unit 100 can make the user feel that the user is welcomed by the vehicle 10. Convenience of the on-board unit 100 is therefore improved.

The correspondence data may indicate another correspondence (hereafter referred to as the second correspondence) shown in FIG. 4. The second correspondence differs from the first correspondence in that the door 12 for the DR seat corresponds only to the DR lighting device 24 and that the door 14 for the PR rear seat corresponds only to the PR lighting device 25.

As shown in FIG. 2, neighboring communication areas 30a to 30g may overlap. When the user with the mobile communicator 1 comes into an area where two neighboring communication areas overlap, the user may head toward any of doors corresponding to the neighboring communication areas.

According to the second correspondence, the D lighting device 20 and the DR lighting device 24 are turned on at the same time when the user with the mobile communicator 1 comes into an area where the communication areas 30a and 30b overlap. In addition, the P lighting device 21 and the PR lighting device 25 are turned on at the same time when the user with the mobile communicator 1 comes into an area where the communication areas 30c and 30d overlap.

Therefore, the lighting devices corresponding to doors toward which the user may head are tuned on.

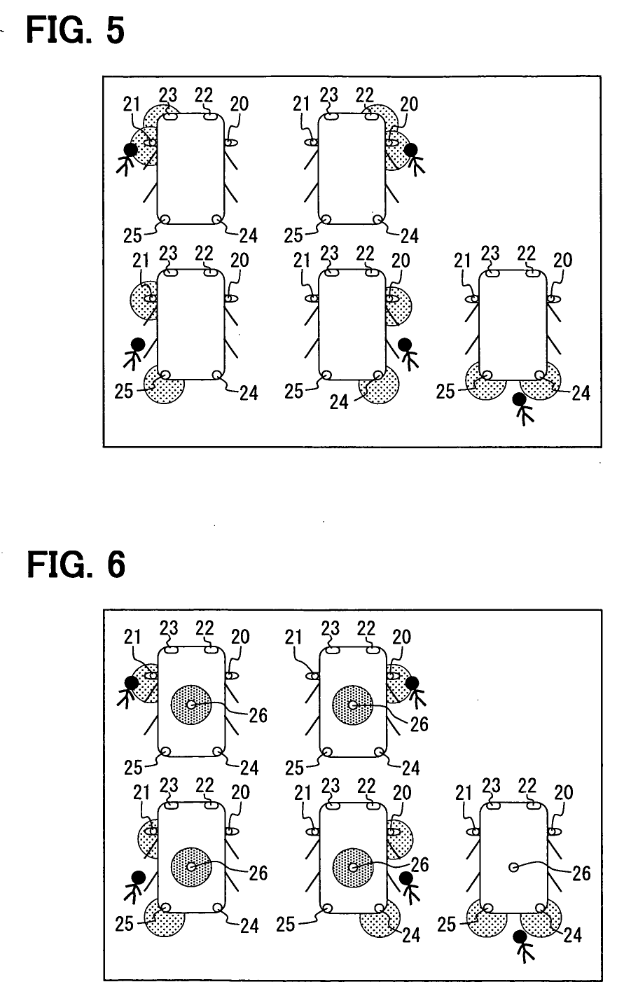

The correspondence data may indicate another correspondence (hereafter referred to as the third correspondence) shown in FIG. 5. The third correspondence differs from the first correspondence in that the door 11 for the driver's seat corresponds to the DF lighting device 20 and the D lighting device 22 and that the door 13 for the passenger's seat corresponds to the PF lighting device 21 and the PR lighting device 23.

The correspondence data may indicate another correspondence (hereafter referred to as the fourth correspondence) shown in FIG. 6. The fourth correspondence differs from the first correspondence in that the door 11 for the driver's seat, the door 13 for the passenger's seat, the door 12 for the DR seat and the door 14 for the PR seat additionally correspond to the R lighting device 26.

Other correspondences may be determined between the doors and lighting devices including the direction indicator, the fog light, the cornering light, the brake light and the reverse light.

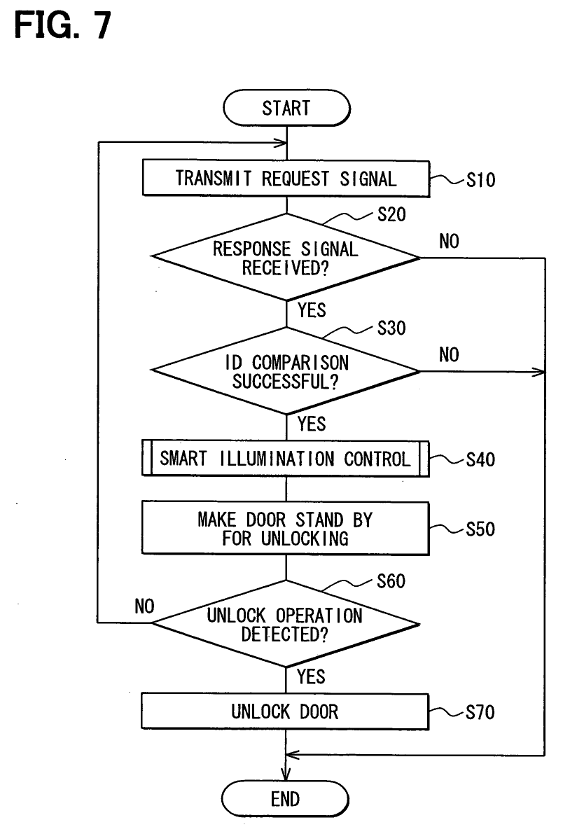

Next, a detailed description is given, with reference to a flowchart in FIG. 7, of operations of the comparison ECU 4, body ECU 7 and the Illumination ECU 19 based on the result of the comparison of the user ID for unlocking the doors 11 to 15 and for executing the smart illumination control. The process shown in the flowchart is executed repeatedly at a predetermined interval while an engine of the vehicle 10 is not operating and the doors 11 to 15 are locked.

At step S10, the comparison ECU 4 outputs to the vehicle exterior transmitters 2a to 2e the command signal in order to cause the vehicle exterior transmitters 2a to 2e to transmit the request signals including respective transmitter codes. Subsequently at step S20, the comparison ECU 4 makes a determination whether the receiver 3 has received the response signal from the mobile communicator 1 in response to one of the request signals. When the determination at step S20 is negative (NO), that is, when the comparison ECU 4 determines that the mobile communicator 1 is not in the communication areas 30a to 30e of the vehicle exterior transmitters 2a to 2e, the comparison ECU 4 stops executing the process shown in FIG. 7. When the determination at step S20 is affirmative (YES), the comparison ECU 4 subsequently executes step S30.

At step S30, the comparison ECU 4 makes a comparison as to whether the user ID code in the response signal has the predetermined relation with the user authentication code. When the comparison at step S30 is affirmative, the comparison ECU 4 subsequently executes step S40. When the comparison at step S30 is negative, that is, when the user ID code does not have the predetermined relation with the user authentication code, the comparison ECU 4 subsequently stops executing the process shown in FIG. 7.

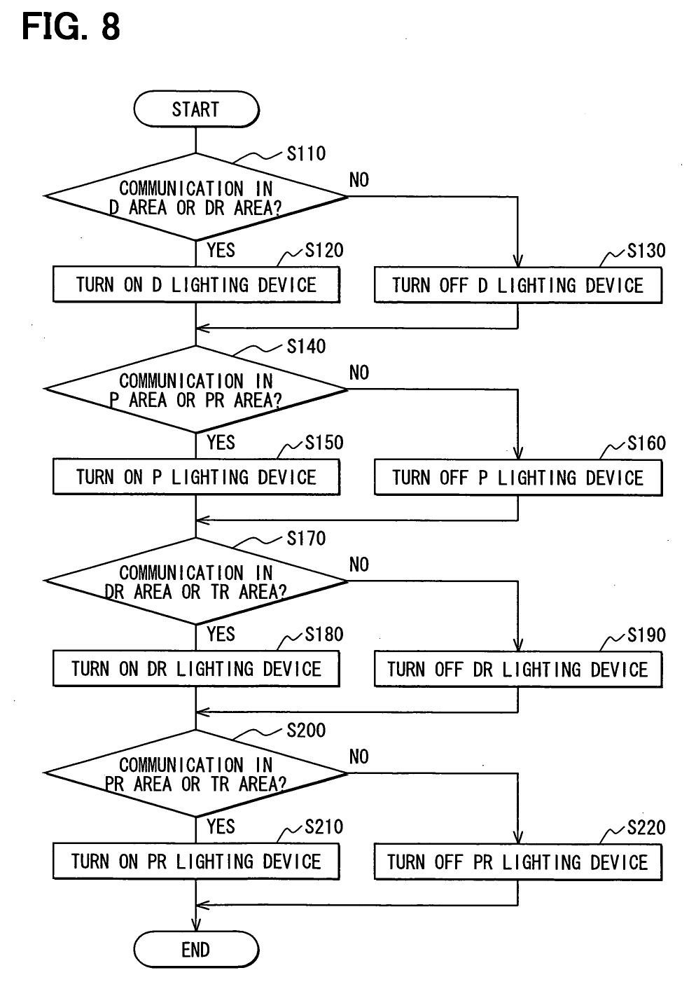

At step S40, the comparison ECU 4 executes the smart illumination control, which is described in detail later with reference to FIG. 8. The smart illumination control in step S40 is executed while the doors 11 to 15 are locked, as described in detail below.

At step S50, the comparison ECU 4 specifies, based on the transmitter code included in the response signal or on the time instant of receiving the response signal, one of the vehicle exterior transmitters 2a to 2e from which the mobile communicator 1 has received the request signal. The locations of the vehicle exterior transmitters 2a to 2e correspond (more specifically, are close to) respective positions of the doors 11 to 15. The comparison ECU 4 activates one of the touch sensors 6a1 to 6e1 of one of the doors 11 to 15 corresponding to the specified vehicle exterior transmitter. Thus, the one of the doors 11 to 15 becomes ready for unlocking.

At step S60, the comparison ECU 4 determines, by means of a signal from the activated touch sensor, whether one of the door handles 6a to 6e of the door ready for unlocking is operated by the user with the mobile communicator 1.

The comparison ECU 4 waits for the operation to the door handle until the operation is detected. However, the comparison ECU 4 executes steps S10 to S50 again when the operation has not been detected for a predetermined period.

When the determination at step S60 is affirmative, the comparison ECU 4 subsequently executes step S70 and causes the body ECU 7 to unlock the doors 11 to 15. Thus, the user with the mobile communicator 1 and other persons who are going to get into the vehicle 10 can simply open the doors 11 to 15 without making any additional operation for unlocking the doors 11 to 15.

The illumination ECU 19 of the illumination control apparatus 9 executes the smart illumination control shown in FIG. 8 to control the lighting devices 20, 21, 24 and 25 according to the first correspondence shown in FIG. 3 based on the information from the comparison ECU 4 regarding one of the vehicle exterior transmitters 2a to 2e which has transmitted the request signal received by the mobile communicator 1.

In the smart illumination control, the illumination ECU 19 makes a determination at step S110 whether the mobile communicator 1 has communicated with one or more of the vehicle exterior transmitters 2a to 2e at a place included by at least one of the communication area (hereafter referred to as a D area) 30a adjacent to the driver's seat and the communication area (hereafter referred to as a DR area) 30b adjacent to the DR seat. When the determination at step S110 is affirmative, the illumination ECU 19 turns on the D lighting device 20 at step S120. This is because the D lighting device 20 should be tuned on in both cases when the user with the mobile communicator 1 is coming closer to the door 11 for the driver's seat and when the user with the mobile communicator 1 is coming closer to the door 12 for the DR seat. When the determination at step S110 is negative, the illumination ECU 19 turns off the D lighting device 20 at step S130.

At step S140, the illumination ECU 19 makes a determination whether the mobile communicator 1 has communicated with one or more of the vehicle exterior transmitters 2a to 2e at a place included by at least one of the communication area (hereafter referred to as a P area) 30c adjacent to the passengers seat and the communication area (hereafter referred to as a PR area) 30d adjacent to the PR seat. When the determination at step S140 is affirmative, the illumination ECU 19 turns on the P lighting device 21 at step S150. Thus, the P lighting device 21 is tuned on in both cases when the user with the mobile communicator 1 comes close to the door 13 for the driver's seat and when the user with the mobile communicator 1 comes close to the door 14 for the PR seat. When the determination at step S140 is negative, the illumination ECU 19 turns off the P lighting device 21 at step S160.

At step S170, the illumination ECU 19 makes a determination whether the mobile communicator 1 has communicated with one or more of the vehicle exterior transmitters 2a to 2e at a place included by at least one of the DR area 30b and the communication area (hereafter referred to as a TR area) 30e adjacent to the trunk room of the vehicle. When the determination at step S170 is affirmative, the illumination ECU 19 turns on the DR lighting device 24 at step S180. Thus, the DR lighting device 24 is tuned on in both cases when the user with the mobile communicator 1 comes close to the door 12 for the DR seat and when the user with the mobile communicator 1 comes close to the door 15 for the trunk room. When the determination at step S170 is negative, the illumination ECU 19 turns off the DR lighting device 24 at step S190.

At step S200, the illumination ECU 19 makes a determination whether the mobile communicator 1 has communicated with one or more of the vehicle exterior transmitters 2a to 2e at a place included by at least one of the PR area 30d and the TR 30e. When the determination at step S200 is affirmative, the illumination ECU 19 turns on the PR lighting device 25 at step S210. Thus, the PR lighting device 25 is tuned on in both cases when the user with the mobile communicator 1 comes close to the door 14 for the PR seat and when the user with the mobile communicator 1 comes close to the door 15 for the trunk room. When the determination at step S200 is negative, the illumination ECU 19 turns off the PR lighting device 24 at step S220.

The illumination ECU 19 turns off the lighting devices which have been tuned on by the smart illumination control when the user with the mobile communicator 1 gets into the vehicle 10. The illumination ECU 19 detects, based on opening and closing of one of the doors 11 to 15 or start of the engine, that the user with the mobile communicator 1 gets into the vehicle 10.

As described above, it is possible to properly control the lighting devices of the vehicle 10 when the user comes close to the vehicle 10 with the mobile communicator 1, by executing the smart illumination control.

The present invention should not be limited to the embodiment discussed above and shown in the figures, but may be implemented in various ways without departing from the spirit of the invention.

For example, multiple antennas may be provided at different portions of the vehicle 10, and the on-board unit 100 may receive a door control signal from the mobile communicator 1 at the same time at the multiple antennas. The on-board unit 100 may then determine location of the mobile communicator 1 based on difference of intensities of the door control signal received at the multiple antennas. The on-board unit 100 may then turn on one or a limited number of the lighting devices 20 to 26 which are closer to the determined location of the mobile communicator 1 than others of the lighting devices 20 to 26.

In this case, the on-board unit 100 does not have to transmit the request signals. In addition, the mobile communicator 1 may transmit the door control signal in response to a user's manual operation to the mobile communicator 1 for remotely controlling door conditions.

What is claimed is:

1. An on-board illumination controlling system for a vehicle, comprising:
a mobile communicator which receives one of request signals and transmits, in response to the received request signal, a response signal; and
an on-board unit for transmitting the request signals, receiving the response signal, and controlling based on the received response signal multiple lighting devices installed to the vehicle,
wherein the on-board unit includes:
multiple transmitters installed, respectively, to different portions of the vehicle, the multiple transmitters being for transmitting, respectively, the request signals to different communication areas;
a receiver for receiving the response signal from the mobile communicator;
a specifying means for specifying one of the multiple transmitters which has transmitted the one of the request signals in response to which the mobile communicator has transmitted the received response signal; and
a control means for turning on one of the lighting devices corresponding to the specified one of the multiple transmitters.

2. The on-board illumination controlling system according to claim 1, wherein:
the multiple transmitters transmit, respectively, the request signals having different time dependencies;
the mobile communicator composes the response signal to be transmitted so that a time dependency of the response signal varies depending on a time dependency of the received one of the request signal; and
the specifying means specifies the one of the multiple transmitters based on the time dependency of the received response signal.

3. The on-board illumination controlling system according to claim 1, wherein:
the multiple transmitters transmit, respectively, the request signals in different time periods; and
the specifying means specifies the one of the multiple transmitters based on time instant of receiving the response signal.

4. The on-board illumination controlling system according to claim 1, wherein:
the multiple transmitters are installed, respectively, close to different doors of the vehicle;
the communication areas are located close to the different doors, respectively;
each of the doors corresponds to one or more of the multiple lighting devices; and
the one of the lighting devices which the control means turns on corresponds to one of the doors close to the specified one of the multiple transmitters.

5. The on-board illumination controlling system according to claim 1, wherein the control means turns on the one of the lighting devices based on that doors of the vehicle are locked.

6. The on-board illumination controlling system according to claim 1, wherein,
the mobile communicator receives another one of the request signals and transmits, in response to the received another one of the request signals, another response signal;
the on-board unit receives the another response signal, and controlling based on the received another response signal the multiple lighting devices;
the receiver receives the another response signal from the mobile communicator;
the specifying means specifies another one of the multiple transmitters which has transmitted the another one of the request signals in response to which the mobile communicator has transmitted the received another response signal; and
the control means turns on at the same time:
the one of the lighting devices corresponding to the one of the doors close to the specified one of the multiple transmitters; and
another one of the lighting devices corresponding to another one of the doors close to the specified another one of the multiple transmitters.

7. The on-board illumination controlling system according to claim 1, wherein the lighting devices include one of a lighting device installed under a side mirror of the vehicle, a position light, a direction indicator, a fog light, a cornering light, a brake light, a reverse light and a lighting device installed in a passenger's compartment of the vehicle.

8. The on-board illumination controlling system according to claim 4, further comprising a storage device storing correspondence data between the doors and the lighting devices, wherein the control means specifies the one of the lighting devices based on the correspondence data.

9. The on-board illumination controlling system according to claim 4, wherein:
the doors includes:
a first door adjacent to a driver's seat of the vehicle;
a second door adjacent to a rear seat just behind the driver's seat;
a third door adjacent to a passenger's seat of the vehicle; and
a fourth door adjacent to a rear seat just behind the passenger's seat,
the first door corresponds to a first lighting device below a side mirror next to the first door; and
the second door corresponds to a second lighting device at a rear portion of the vehicle behind the driver's seat;
the third door corresponds to a third lighting device below a side mirror next to the third door;
the fourth door corresponds to a fourth lighting device at a rear portion of the vehicle behind the passenger's seat.

10. An on-board illumination controlling method for a vehicle having a plurality of lighting devices provided at different positions and an on-board unit for communication with a mobile communicator carried by a vehicle user, the method comprising:
receiving, by the on-board unit, a signal transmitted from the mobile communicator for remotely controlling door condition of the vehicle;
determining, by the on-board unit, location of the mobile communicator based on a received signal; and
turning on, by the on-board unit, one or a limited number of the lighting devices which are closer to a determined location of the mobile communicator than others of the lighting devices.
